(19) United States
(12) Patent Application Publication
(10) Pub. No.: US 2011/0085883 A1
(43) Pub. Date: Apr. 14, 2011

(54) ADJUSTABLE WEAR AND DIVERSION DEVICE FOR BULK MATERIAL TRANSFER SYSTEMS AND METHOD OF USING THE SAME

(75) Inventors: Robert Todd Swinderman, Palm Coast, FL (US); Travis John Miller, Sheffield, IL (US)

(73) Assignee: MARTIN ENGINEERING COMPANY, Neponset, IL (US)

(21) Appl. No.: 12/576,833

(22) Filed: Oct. 9, 2009

(51) Int. Cl. B65G 49/00; B65G 11/16

(52) U.S. Cl. 414/800; 193/2 R

(57) ABSTRACT

A wear device for a bulk material transfer system comprises a first wear member and an attachment mechanism. The attachment mechanism is connected to the first wear member and is lockable in a manner that fixes the first wear member in a first position relative to the flow path of the bulk material. The attachment mechanism is also selectively unlockable in a manner such that the first wear member can be moved toward the flow path to a second position. Still further, the attachment mechanism is lockable in a manner that fixes the first wear member in the second position relative to the flow path.

### CROSS-REFERENCE TO RELATED APPLICATIONS

Not Applicable

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention pertains generally to bulk material transfer and storage systems. More particularly, this invention pertains to an adjustable wear device the is configured and adapted to serve as a wear surface on bulk material storage and chute transfer devices of the type used in connection with belt conveyors.

2. General Background

Bulk material transfer systems, including belt conveyors, often transfer highly abrasive material, such as diamond ore. Other bulk materials often not thought of as abrasive, such as grains, are transferred in such large quantities that they also abrade the surfaces of material handling equipment. Such material has a tendency to wear through portions of chutes that are used to direct bulk material onto belt conveyors. The wear is often in localized regions that tend to wear at a much greater rate than other portions of the chute. Thus, chutes and other parts of bulk material transfer systems that come into contact with moving bulk material are often intermittently patched. In some cases, replaceable wear liners are used to protect chutes and other components. Typically, such wear liners are positioned between the bulk material and the component being protected at locations where the bulk material would otherwise rub against the component. When a wear liner wears to the point that it needs replacement, the bulk material transfer system usually must be shut down in order to replace the wear liner. In a typical bulk material transfer chute, such wear liners are replaced from the inside of the chute, often creating a confined space entry situation. A drawback of using wear liners is that they narrow the passageway through which the bulk material must travel and they are heavy to handle in restricted spaces. As a result, the wear liners are generally relatively thin and therefore wear out relatively quickly.

Another method of reducing wear in chutes is to use the bulk material itself to act as a liner. This can be done by provided a ledge inside the chute upon which bulk material accumulates. The accumulated bulk material then absorbs the abrasive impact of other passing bulk material. While this solution does not require as frequent replacement of wear components, it requires a significant amount of space and it can only be used in specific locations of a chute since it relies on gravity flow and with a limited range of bulk materials that do not degrade or self combust over time.

Another problem with the movement and storage of bulk materials is that the properties of the bulk material change over time, which impacts how such bulk material flows through a transfer system. For example, as different ore seams are mined or as environmental or processing conditions change, there is often a need to manage the flow of the changing bulk materials through a system by adjusting flow surfaces to keep it flowing in the direction and at a rate that is acceptable.

### SUMMARY OF THE INVENTION

The present invention solves many problems associated with previous techniques for dealing with wear in bulk material transfer systems. The wear device of the present invention provides a wear member that can be intermittently adjusted such that its wear face can maintain generally the same relative position as the wear member wears down. Additionally, the adjustability of the wear device allows the device to serve as an adjustable bulk material diverter which can be adjusted to accommodate ever changing operating conditions to manage the flow path of a bulk material. Still further, such adjustments can be made while the bulk material transfer system is operating.

In one aspect of the invention, a wear device for a bulk material transfer system comprises a first wear member and an attachment mechanism. The bulk material transfer system has a flow path along which bulk material travels. The first wear member has a wear surface that faces the flow path of the bulk material transfer system and that is configured and adapted to engage bulk material traveling along the flow path. The first wear member thereby partially defines the flow path of the bulk material transfer system. The attachment mechanism is connected to the first wear member and is lockable in a manner that fixes the first wear member in a first position relative to the flow path. The attachment mechanism is also selectively unlockable in a manner such that the first wear member can be moved toward the flow path to a second position. Still further, the attachment mechanism is lockable in a manner that fixes the first wear member in the second position relative to the flow path.

In another aspect of the invention, a method comprises diverting bulk material flowing along a flow path of a bulk material transfer system by engaging the bulk material with a wear member. The method also comprises locking the wear member in a first position relative to the flow path via an attachment mechanism. Furthermore, the method comprises adjusting the attachment mechanism in a manner that moves the wear member from the first position towards the bulk material to a second position. Still further, the method comprises adjusting the attachment mechanism in a manner that moves the wear member from the second position towards the bulk material to a third position after the wear member has worn while in the second position.

In still another aspect of the invention, a method comprises operating a bulk material transfer system in a manner such that bulk material is being transferred by the bulk material transfer system along a flow path. The method further comprises intermittently actuating an attachment mechanism while the bulk material transfer system is operating in a manner that moves a wear member toward the flow path. It should be appreciated that the adjustment can be manual based on visual inspection of the inside of the bulk material transfer system or it can be automated by sensing the thickness of the wear member, using an ultrasonic sensor for example, and moving the wear member with an actuator to from a first position to a second position.

Further features and advantages of the present invention, as well as the operation of the invention, are described in detail below with reference to the accompanying drawings.

### BRIEF DESCRIPTION OF THE DRAWINGS

FIG. 1 is a perspective view of an embodiment of a wear device in accordance with the invention and is shown with one of its wear members and a locking plate disconnected from the assembly.

FIG. 2 depicts a jackscrew of the type used to adjust the wear members of the wear device shown in FIG. 1.

FIG. 3 is an exploded view of the jackscrew shown in FIG. 2.

FIG. 4 is a perspective view of a bulk material transfer chute incorporating wear devices in accordance with the invention and is shown positioned above a bulk material belt conveyor.

FIG. 5 is another embodiment of a wear device in accordance with the invention, which is configured to serve as a chute scoop.

FIG. 6 is a perspective view of a bulk material transfer chute incorporating automated wear devices in accordance with the invention.

Reference numerals in the written specification and in the drawing figures indicate corresponding items.

### DETAILED DESCRIPTION

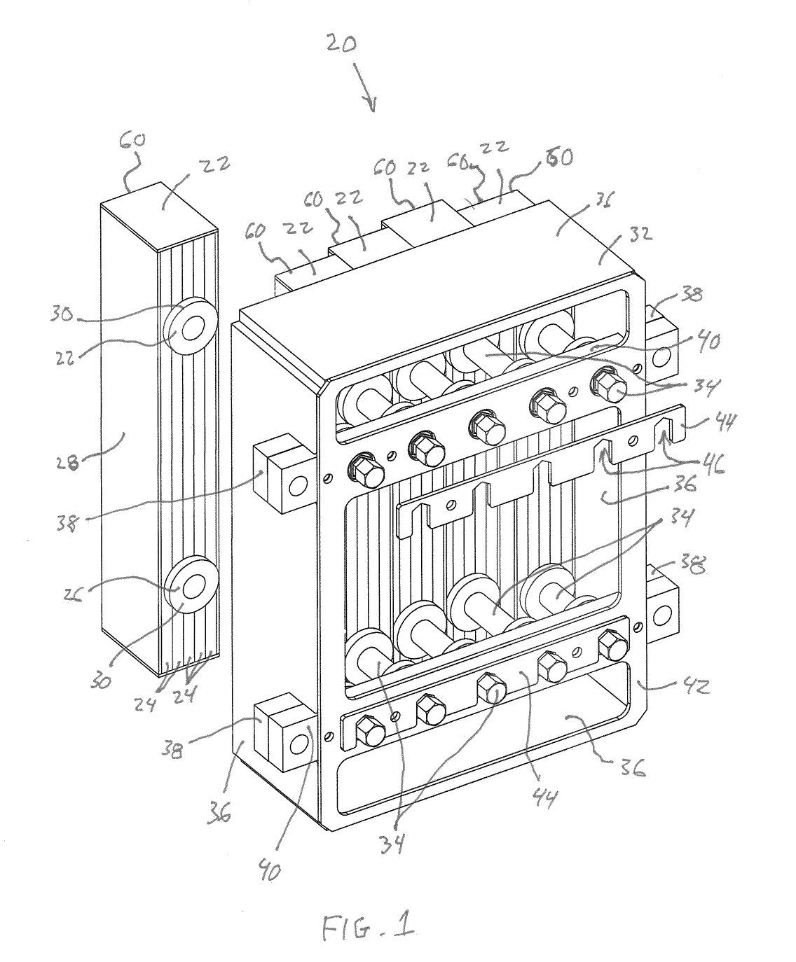

A embodiment of a wear device in accordance with the invention is shown in FIG. 1. The wear device 20 comprises a stack of several wear members 22 that, as explained below, are each independently movable relative to each other. Each wear member 22 is itself comprised of a stack of plates 24 formed of abrasion resistant steel. Each wear member 22 also comprises two female threaded inserts 26 and a low friction casing 28. Each threaded insert 26 comprises a collar 30 that is welded to each of the plates 24 of the respective wear member 22, and thereby rigidly fixes the plates 24 to each other. The low friction casing 28 of each wear member 22 is formed of a thin layer of a non-corrosive polymer, such a polyethelene, and encircles and is adhered to the wear member 22. The low friction casings 28 prevent the wear members 22 from chemically bonding to each other in corrosive environments. It should be appreciated however that the casings 28 is not essential and that a single sheet of polymer rather than a casing between each adjacent pair of wear members would serve the same purpose. Moreover, it should be appreciate that wear members formed of other materials, such as polyethelene, that are not subject to corrosion would not need any low friction or corrosion resistant casings or sheets.

The wear device 20 also comprises a housing 32 which connects and supports the wear members 22. The housing 32 comprises an adjustment mechanism that includes a plurality of jackscrews 34. The housing also comprise four side walls 36, four lugs 38, two crossbars 40, a cover plate 42, and two locking plates 44. The four side walls 36 collectively encircle the wear members 22 and are welded to each other. Two of the lugs 38 are welded to one of the side walls 36 and the other two lugs are welded to the opposite side wall. Each crossbar 40 is removably attached to a pair of the lugs 38, preferably via threaded fasteners (not shown). The cover plate 42 covers exposed edges of the side walls 36 and is preferably removably attached to the crossbars via threaded fasteners (not shown). Each locking plate 44 comprises a plurality of grooves 46 and is removable attached to the cover plate 42 of one of the crossbars 40, preferably via threaded fasteners (not shown).

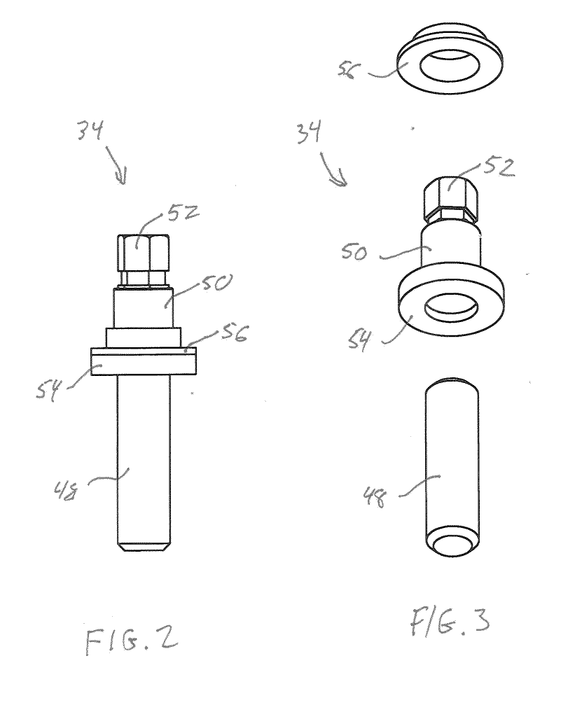

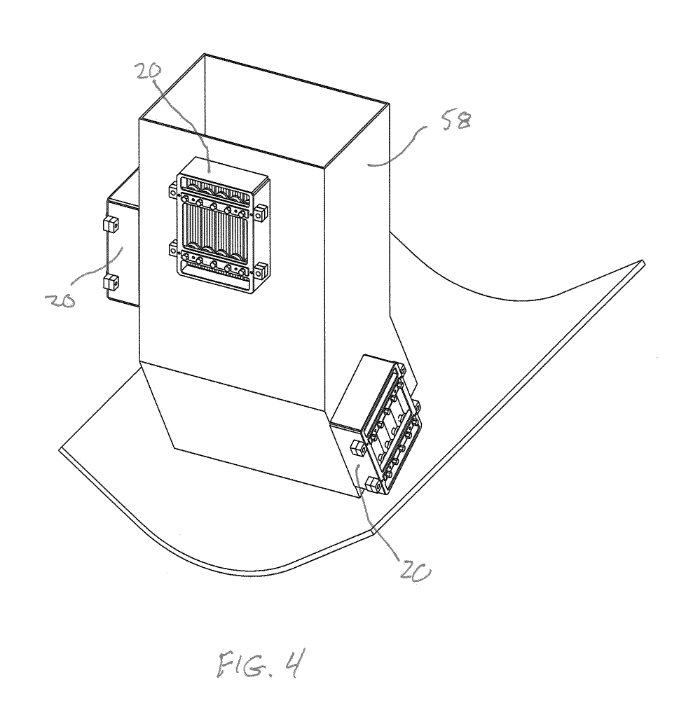

One of the jackscrews 34 is shown in FIG. 2. FIG. 3 depicts an exploded view of the jackscrew 34. The jackscrew 34 comprises a portion of threaded rod 48 that is welded to machined cap 50. The cap 50 comprises a hexhead 52 and annular flange 54. A low friction washer 56 encircles the cap 50 and slidably engages the annular flange 54. The hexhead 52 of the cap 50 of each jackscrew extends through a respective hole though one of the crossbars 40 and a corresponding hole in the cover plate 42. The washer 56 and annular flange 54 have a diameter that is larger than the corresponding hole through the crossbar 40 in a manner that prevents the entire jackscrew 34 from passing though the hole of the crossbar. The washers 56 reduce the friction between the crossbars 40 and the jackscrews 34. The threaded rods 48 of the jackscrews 34 are threadably engaged with the threaded inserts 26 of wear members 22 in a manner such that each wear member is secured to the housing 32 by two of the jackscrews. Each of the locking plates is aligned with a respective row of the jackscrews 34. The grooves 46 in each locking plate 44 is slightly narrower than the hexheads 52 of the jackscrews 34, but slide down around necked down hex portions of the caps 50. The locking plate 44 thereby prevent the removal of the jackscrews 34 from the crossbars 40, and also prevent the jackscrews from rotating relative to the crossbars.

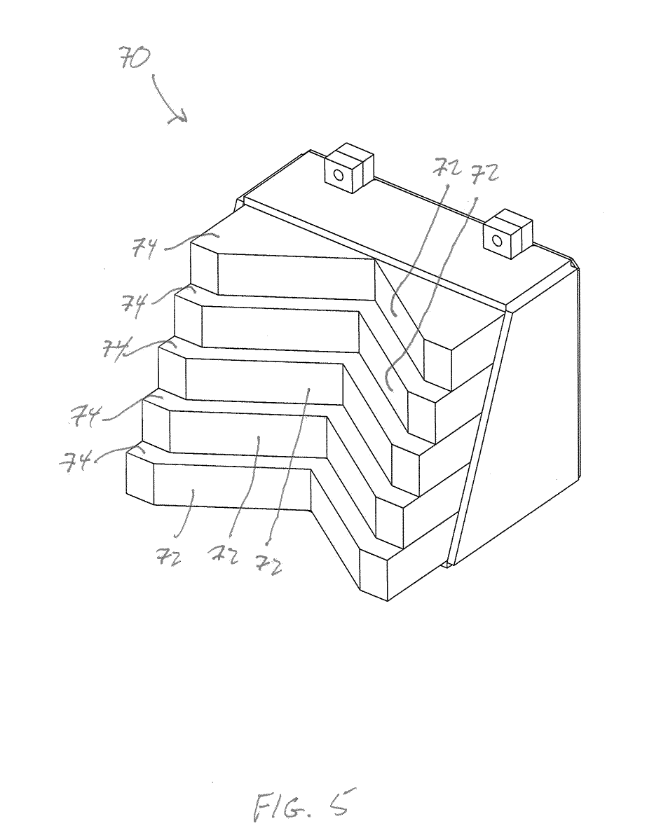

In use, the side walls 36 of the housing 32 are welded to a bulk material transfer system, such as a chute 58 like the one depicted in FIG. 4. It should be appreciate the chute 58 comprises an opening that is dimensioned to allow the wear members 22 of the wear device 20 to extend therethrough. When serving as merely a wear surface in the chute 58 the exposed faces 60 of the wear members 22 are preferably aligned with the inner contour of the chute. During the operation of the bulk material transfer system, bulk material impacts and slowly abrades the wear members 24. However, the wear device 20 can be adjusted at anytime from the outside of the chute to compensate for the amount of wear that has occurred. This is done by first removing the locking plates 44, which when attached, capture the jackscrews 34 and prevent them from rotating. With the locking plates 44 off, the jackscrews 34 can be rotated in manner that moves the wear members 22 toward the flow path of the bulk material by creating compression between the crossbars 40 and the wear members. It should be appreciated that each wear member 22 can be moved independently of the other wear members. Thus, regardless of the wear pattern, the wear device 20 can be adjusted intermittently to maintain the exposed faces 60 of the wear members 22 in alignment with the inner contour of the chute 58. It should also be appreciated the jackscrews 34 described above partially retract from the wear members 22 as the wear members move towards the interior of the chute 58. As such, ore debris and corrosion will not prevent the jackscrews 34 from operating. Still further, it should be appreciated that, since the wear device 20 is adjusted from the exterior of the chute 58, the wear device can be adjusted while the bulk material transfer system is in operation.

When any of the wear members 22 become excessively worn and is need of replacement, this too can be performed while the bulk material transfer system is operating. To replace any of the wear members 22, the operator merely removes the crossbars 40 from the wear device 20, thereby allowing the wear member to be pulled out of the wear device from the exterior side of the system.

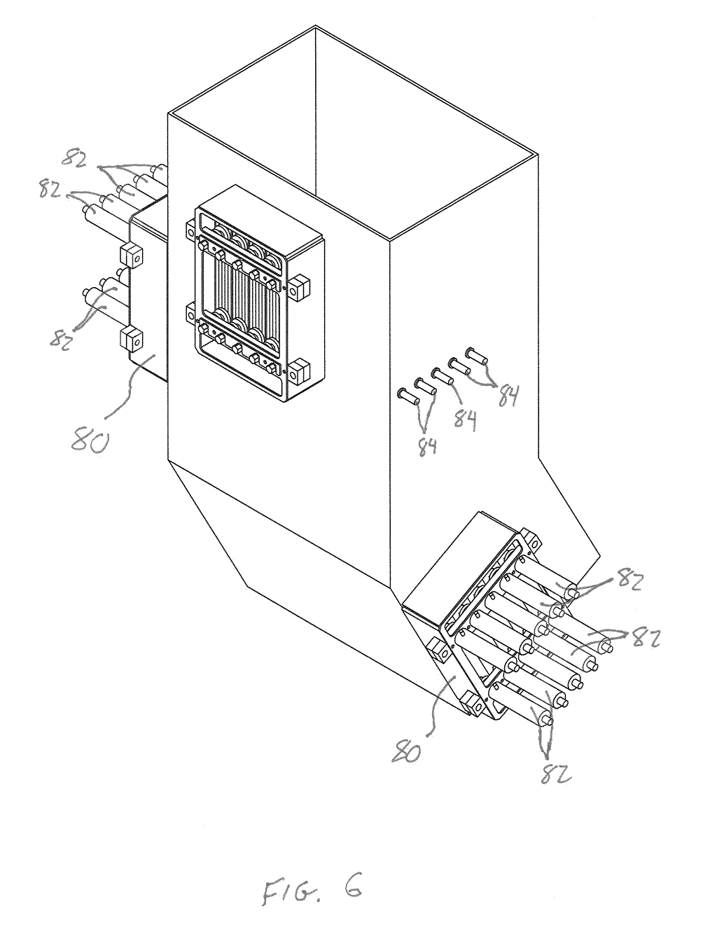

In addition to serving as merely a wear surface, a wear device in accordance with the invention can be configured to serve as a chute scoop or any other type of bulk material diverter. A wear device configured to serve as a chute scoop 70 is shown in FIG. 5. As shown, the wear faces 72 of the wear members 74 of the chute scoop 70 can be shaped specifically to channel bulk material toward the center of a conveyor belt.

FIG. 6 depicts a chute having automated wear devices. The automated wear devices 80 comprise powered actuators 82 that are capable of moving the wear members 22 in response to signals. The actuators 82 may be hydraulically, pneumatically, or electrically driven. Sensors 84 are provided that measure some aspect of the wear members and generate a signal upon which it can be determined whether the position of the wear members should be adjusted. The sensors 84 may be virtually any type of sensors, including ultrasonic sensors or laser measurement sensors that measure distances and sensors built into the wear members that sense wear directly. The actuators 82 can then be actuated via a controller (not shown) that is responsive to the signals.

In view of the foregoing, it should also be appreciate that a limitless number of other configurations of a wear device in accordance with the invention can be made to serve other desired purposes. In addition the invention can be adapted to be used on any wear surface including chute corners, hopper edges, and even curved surfaces such as flow deflectors or pipes. Still further, it should be appreciated that, if desired, a wear device can include both vertically and horizontally stacked wear members used in combination. Additionally, it should be appreciated that the wear member could be formed as a single monolithic block of material, which could be almost any material, and threaded holes could be cut into the block as an alternative to using the threaded inserts described above.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

What is claimed is:

1. A wear device for a bulk material transfer system, the bulk material transfer system having a flow path along which bulk material travels, the wear device comprising:
a first wear member, the first wear member having a wear surface that faces the flow path of the bulk material transfer system and that is configured and adapted to engage the bulk material traveling along the flow path, the first wear member thereby partially defining the flow path of the bulk material transfer system;
an attachment mechanism, the attachment mechanism being connected to the first wear member and being lockable in a manner that fixes the first wear member in a first position relative to the flow path, the attachment mechanism also being selectively unlockable in a manner such that the first wear member can be moved toward the flow path to a second position, the attachment mechanism further being lockable in a manner that fixes the first wear member in the second position relative to the flow path.

2. A wear device in accordance with claim 1 wherein the attachment member comprises at least one jackscrew having an longitudinal axis, and the jackscrew is rotatable about the longitudinal axis in a manner that moves the first wear member toward the flow path.

3. A wear device in accordance with claim 2 wherein the first wear member comprises a threaded hole, the jackscrew is threadably engaged with the threaded hole, and the jackscrew partially withdraws from the threaded hole as first wear member moves from the first position to the second position.

4. A wear device in accordance with claim 1 wherein the wear device comprises a stack of wear members that includes the first wear member and a second wear member, the second wear member has a wear surface that faces the flow path of the bulk material transfer system and that is configured and adapted to alter the direction of bulk material traveling along the flow path, the second wear member thereby partially defines the flow path of the bulk material transfer system, the attachment mechanism is connected to the second wear member and is lockable in a manner that fixes the second wear member in a first position relative to the flow path, the attachment mechanism is selectively unlockable in a manner such that the second wear member can be moved toward the flow path to a second position, the attachment mechanism is lockable in a manner that fixes the second wear member in the second wear member's second position relative to the flow path, and the attachment mechanism allows the first and second wear members to be moved independently of each other from their respective first positions to their respective second positions.

5. A wear device in accordance with 1 wherein the wear device is configured in a manner such that when first wear member moves from the first position to the second position, the wear member moves in a direction that is generally perpendicular to the flow path.

6. A bulk material transfer system comprising a wear device in accordance with claim 1 and a bulk material transfer chute, the wear device being attached to the chute via the attachment mechanism.

7. A method comprising:
diverting bulk material flowing along a flow path of a bulk material transfer system by engaging the bulk material with a wear member;
locking the wear member in a first position relative to the flow path via an attachment mechanism;
adjusting the attachment mechanism in a manner that moves the wear member from the first position towards the bulk material and to a second position; and
adjusting the attachment mechanism in a manner that moves the wear member from the second position towards the bulk material and to a third position after the wear member has worn while in the second position.

8. A method in accordance with claim 7 wherein the step of adjusting the attachment mechanism in the manner that moves the wear member from the second position towards the bulk material and to the third position occurs while the bulk material transfer system is operating.

9. A method in accordance with claim 8 wherein the engagement of the bulk material with the wear member occurs within a bulk material transfer chute, and the step of adjusting the attachment mechanism in the manner that moves the wear member from the second position towards the bulk material and to the third position is performed from a location exterior to the chute.

10. A method in accordance with claim 7 wherein the wear member constitutes a first wear member and the method further comprises:
diverting bulk material flowing along the flow path of the bulk material transfer system by engaging the bulk material with a second wear member;
locking the second wear member in a first position relative to the flow path via the attachment mechanism;
adjusting the attachment mechanism in a manner that moves the second wear member from the second wear member's first position towards the bulk material and to a second position; and
adjusting the attachment mechanism in a manner that moves the second wear member from the second wear member's second position towards the bulk material and to a third position after the second wear member has worn while in the second wear member's second position.

11. A method in accordance with claim 10 wherein each of the steps of adjusting the attachment mechanism comprises turning at least one screw.

12. A method comprising:
operating a bulk material transfer system in a manner such that bulk material is being transferred by the bulk material transfer system along a flow path;
intermittently actuating an attachment mechanism while the bulk material transfer system is operating in a manner that moves a wear member toward the flow path.

13. A method in accordance with claim 12 wherein the bulk material transfer system comprises a bulk material chute and the attachment mechanism connects the wear member to the chute.

14. A method in accordance with claim 12 wherein the wear member constitutes a first wear member and the method further comprises intermittently actuating the attachment mechanism while the bulk material transfer system is operating in a manner that moves a second wear member toward the flow path.

15. A method in accordance with claim 14 wherein each of the steps of intermittently adjusting the attachment mechanism comprises turning at least one screw.

16. A method in accordance with claim 12 wherein the wear member comprises a wear face that faces the flow path, and the method further comprises:
generating an electronic signal via a sensor, the electronic signal being indicative of the position of the wear face of the wear member relative to another portion of the bulk material transfer system; and
automatically actuating the attachment mechanism in response to the signal in a manner that moves a wear member toward the flow path.
